(19) United States
(12) Patent Application Publication
(10) Pub. No.: US 2026/0055756 A1
(43) Pub. Date: Feb. 26, 2026

(54) NON-IMAGING NON-TRACKING SOLAR CONCENTRATOR BASED COMBINED CSP AND WAVE ENERGY AND WIND ENERGY CONVERSION HYBRID THERMAL ENERGY AND ELECTRIC POWER COGENERATION SYSTEM

(71) Applicant: Yonghua Wang, Klamath Falls, OR (US)

(72) Inventor: Yonghua Wang, Klamath Falls, OR (US)

(21) Appl. No.: 18/831,167

(22) Filed: Aug. 22, 2024

(51) Int. Cl. F03D 9/00; F03D 9/11; F03D 9/18; F03D 9/32; F24S 23/30

(52) U.S. Cl. CPC F03D 9/007; F03D 9/008; F03D 9/11; F03D 9/18; F03D 9/324; F24S 23/31

(57) ABSTRACT

A combined stationary solar CSP, wave motion, and wind power generation and fresh water production system that deploys close structure non-imaging non-tracking solar concentrator array as buoy for wave motion converter system and floating platform for wind mills comprises a divergent Fresnel lens and non-imaging concentrator enabled non-imaging non-tracking solar concentrator based hybrid solar thermal and photovoltaic CSP system, a wave energy converter system, and a vertical axis wind energy system. Wherein, the stationary solar CSP system realizes ultra-high efficiency through solar thermal and photovoltaic cogeneration, substantially-low cost through stationary high concentration ratio concentration, and super-stable power generation through electrothermal energy storage. The system produces fresh water through thermal power generation and uses swappable battery modules to address power transportation and utilization issues.

### TECHNICAL FIELD

The present disclosure relates generally to solar energy conversion, wave energy conversion, and wind energy conversion, more specifically, to non-imaging non-tracking stationary solar concentrator based combined CSP, wave energy conversion, and wind energy conversion comprehensive systems for electric and thermal energy cogeneration.

### BACKGROUND

“The sun provides Earth with as much energy every hour as human civilization uses every year. If you are a solar-energy enthusiast, that says it all. No other energy supply could conceivably be as plentiful as the 120,000 terawatts the sun provides. ceaselessly and unbidden. If the tiniest fraction of that sunlight were to be captured by photovoltaic cells that turn it straight into electricity, there would be no need to emit any greenhouse gases from any power plant.” (Oliver Morton, Nature, 443, 19-22 (2006)). However, due to the extremely low energy current density of solar radiation, which is only 1000w/m² under standard condition, if human being wants to radically address the climate changing and energy depletion issues by completely replacing fossil fuel with solar energy, vast land is needed to collect solar radiation. The conflict of the land uses for power generation and land uses for other purposes will present a grand challenge in front of human being. Ocean occupies more than 70% surface of earth and provides an unparallel solution for solving the land use conflict. However, up to now, ocean floating photovoltaic systems are not widely adopted for power generation. The major obstacles stem from the harsh environment on the ocean due to wave and wind, and the fatal drawbacks of the current solar energy technologies including low efficiency, high cost, and intermittency. In reality, wave energy and wind energy are copious energy resources. A novel approach is necessary to harness the three energy resources simultaneously and synergistically combine the three different technologies together to leverage each other. In the mean time, this novel approach has potential to dramatically increase the conversion efficiency of solar system and effectively address the intermittency of the solar system. Since the novel system is operating on ocean, it is also expected to produce freshwater from sea water when it generates electric power.

U.S. Pat. No. 10,526,056 B1 granted to Hakki et al (Hakki) discloses a method and apparatus for producing electricity from a combination of three sources: ocean waves, wind and solar, includes converting an upward and downward motion of a buoyant platform into a rotational motion of a shaft using a plurality of blades mounted to the shaft, the blades causing the shaft to rotate from internal wind energy as the blades move up and down within a cavity. The shaft is coupled to a generator for producing electricity. A wind turbine is mounted to the buoyant platform for converting wind energy into electricity. Further, solar panels are included, for example, mounted to the buoyant platform and/or turbine blades of the wind turbine, the solar panels also generate electricity when exposed to light. In Hakki's disclosure, flat plate photovoltaic panel or three dimensional hemicylinder-shaped solar cell with low conversion efficiency is simply mounted on the buoyant platform; due to the high cost of the buoyant platform, the area for solar panel is limited; buoyant platform is only used to generate buoyant lifting force but not contribute to solar collection. Hakki's method and apparatus only generates electricity but does not produce freshwater and contribute to energy storage.

U.S. Pat. No. 10,619,620 B2 granted to Skjoldhammer (Skjoldhammer) discloses an apparatus comprising a floating platform, a cylinder connected thereto, and a piston having a piston rod connected to a mooring at the sea floor. At least one penstock tube is in fluid connection at its lower end with a lower portion of the cylinder, below the piston. The penstock tube being provided along the cylinder and has an opening at the upper end arranged so that water pumped upwards in the at least one penstock tube will hit a water turbine arranged above the cylinder. The water turbine being in connection with a generator. The cylinder has an opening in an upper portion and in the lower portion thereof, provided with a one-way valve allowing water into the lower portion of the cylinder while the cylinder moves downwards, and when the plat form rises, water will be refilled in the upper section through the opening. For wave energy conversion, the floating platform is the core component for generating buoyant force. But it does not contribute to solar collection and photovoltaic energy conversion except provides floating support to solar panel, if it is used for power generation from combined sources: sun, wave motion, and wind.

U.S. Pat. No. 11,085,414 B2 granted to Skjoldhammer (Skjoldhammer 2) discloses a floating platform for a wave energy converter (WEC), comprising a hollow body, in which energy converting machinery may be positioned, characterized in that the floating platform has an underside facing the water in use, an upper side facing the opposite direction and a first long-side forming a front and a second long-side forming a back, and two short-sides, wherein at least one aligning means is provided, the aligning means is configured to align the front of the floating platform with the wave front, i.e. perpendicular to the direction of the wave, wherein the front of the floating platform is at least 20 m long. This floating platform is the core component for generating buoyant force. But it does not contribute to solar collection and photovoltaic energy conversion except provides floating support to solar panel, if it is used for power generation from combined sources: sun, wave motion, and wind.

The present invention discloses a method and apparatus that combine solar CSP, wave motion, and wind multiple sources to generate electric power, produce fresh water, and store energy. The disclosed method and apparatus employs non-imaging non-tracking stationary solar concentrators of CSP systems to replace the floating platform of wave energy system for generating buoyant force for wave energy converter while collect sunlight to cogenerate electric power and thermal energy. The cogenerated thermal energy is used to store energy, regenerate electric power, and produce fresh water. On top of the non-imaging non-tracking stationary solar concentrators, wind turbines are added to harness wind energy.

### SUMMARY

According to the present invention a non-imaging non-tracking solar concentrator based combined CSP, wave energy, and wind energy conversion hybrid thermal energy and electric power cogeneration system comprises: 1) a divergent Fresnel lens and non-imaging concentrator enabled large concentration ratio solar concentrator based CSP system; 2) a wave energy converter system with the CSP system as the floating platform; 3) a wind turbine power generation system; 4) a battery module swappable battery bank; wherein the CSP system connect to the wave energy converter system as the floating platform to generate buoyant force; the wind turbine power generation system is mounted on the top of the CSP system. The CSP system cogenerates electricity and thermal energy. The cogenerated thermal energy is used to store energy and the stored thermal energy is extracted out for electric power regeneration by using thermal power generation system. Sea water is purified to produce fresh water during the thermal power generation process. The swappable battery modules are used to energize battery swappable electric vehicles.

The CSP system has demonstrated a great potential in dramatically increase the total conversion efficiency of hybrid solar thermal and photovoltaic systems. The divergent Fresnel lens and non-imaging concentrator enabled non-tracking high concentration ratio solar concentrator based CSP system provides the possibility to replace the floating platform of wave energy conversion system, and therefore synergistically combines CSP system and wave energy conversion system together to cogenerate electricity and thermal energy, realize electrothermal energy storage, and produce freshwater. By adding wind turbines on the top of the CSP system, the present invention enables power generation from multiple sources of the sun, wave motion, and wind.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a schematic indication of the configuration of the non-imaging non-tracking solar concentrator based combined CSP and wave energy and wind energy conversion hybrid thermal energy and electric power cogeneration system disclosed in the present invention.

FIG. 2 is the configuration of the CSP and water desalination system powered by the non-imaging non-tracking high concentration ratio solar concentrator based concentrating hybrid solar thermal and photovoltaic system. The thermal energy cogenerated by the concentrating hybrid system is firstly used to preheat the water, and then the electric energy cogenerated by the concentrating hybrid system is used to raise the temperature of the preheated water for thermal power generation, a partion of the cogenerated electricity is used to boost the temperature of the thermal storage system, finally the steam used for thermal power generation is condensed to produce the fresh water.

FIG. 3 is the illustration of the work principle of the non-imaging solar concentrator. The incident light no matter the diffuse light I_{d} or the beam light I_{b}, as long as their incident angles fall in the half-acceptance angle θ_{C}, will be concentrated onto receiver at the bottom of the non-imaging solar concentrator.

FIG. 4 is the non-imaging solar concentrator covered with a domed divergent Fresnel lens to form a non-imaging non-tracking high concentration ratio solar concentrator.

FIG. 5 is the geometric diagram showing the refraction mechanism that changes the direction of the incident light through the domed divergent Fresnel lens during a diurnal day to realize non-imaging non-tracking high concentration ratio stationary concentration.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

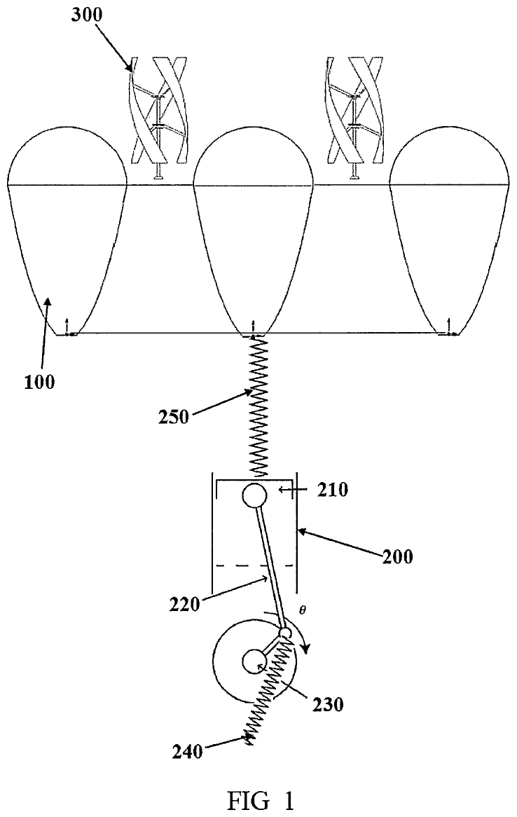

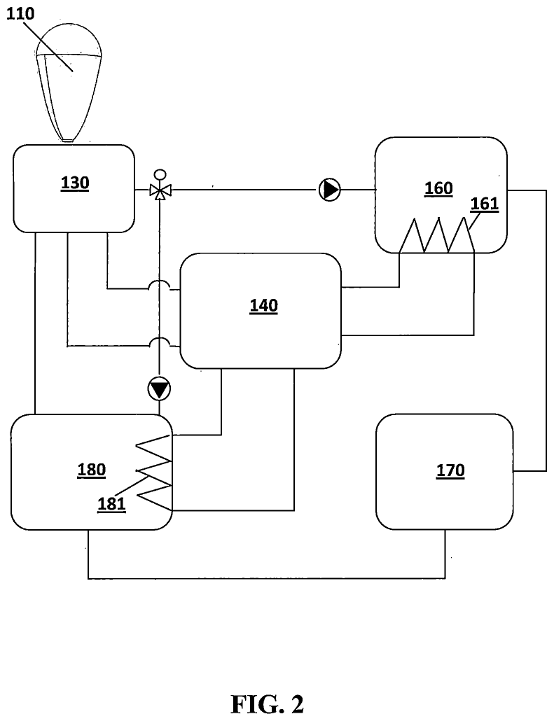

Referring to FIG. 1, the non-imaging non-tracking solar concentrator based combined CSP and wave energy and wind energy conversion hybrid thermal energy and electric power cogeneration system comprises: 1) a divergent Fresnel lens and non-imaging concentrator enabled non-imaging non-tracking solar concentrator based hybrid solar thermal and photovoltaic CSP system 100; 2) a wave energy converter system 200; 3) a vertical axis wind energy system 300; wherein, the CSP system serves as a float platform for the wave energy system to generate electric power and provides support to wind energy system to generate electric power too. The wave energy converter system comprises: a) a piston 210; b) two connection rods 220; c) a crankshaft 230; d) a electric generator (not shown in the figure); e) a flywheel (not shown in the figure); f) a lower spring 240; and g) a upper spring 250. Wherein, the CSP system is connected to the piston of the wave energy converter system through the upper spring; the wave energy converter system is connected to the bed of ocean through the lower spring; the electric generator and the flywheel are connected to the wave energy converter system through the crankshaft. The wave energy converter system and the wind energy system are electrically connected to battery bank (shown in FIG. 2) with swappable battery modules of the CSP system.

Referring to FIG. 2, the CSP system comprises 6 subsystems: (1) non-imaging non-tracking high concentration ratio solar concentrator based concentrating hybrid solar thermal and photovoltaic system, which consists the non-imaging non-tracking high concentration ratio solar concentrator 110, hybrid solar thermal and photovoltaic receiver 130; (2) battery storage 140, which is made of swappable battery modules to address the issue of power grid availability for transportation of power and power utilization for electric vehicles with swappable battery modules; (3) Thermal storage 160, which is used to store the thermal energy cogenerated by the concentrating hybrid solar thermal and photovoltaic system and raise the temperature of the stored heat through the electric heater 161; (4) thermal power generation system 170, which is used to regenerate power from the stored heat; (5) steam condensation system 180, which condenses the residue steam into fresh water after the thermal power generation process with the assistance of electric heater 181 for multiple effect distillation. When in operation, the solar radiation that incident on the non-imaging non-tracking high concentration ratio solar concentrator 110 is concentrated on the hybrid receiver 130 and converted into the thermal energy and electric power simultaneously. The thermal energy is transferred to the thermal storage tank 160, where its temperature is raised up through the electric heater 161. The electric power is stored into the battery storage 140, and then supplied to electric heater 161 to raise temperature of the stored heat. The thermal energy stored in the thermal storage 160 and heated by the electric heater 161 is taken by the thermal power generation system 170 to regenerate power, and then the residue thermal energy is used to generate fresh water in the condenser 180 with assistance of electric heater 181 to enhance fresh water production.

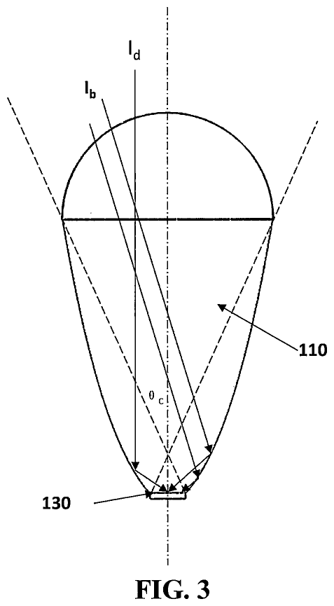

Referring to FIG. 3, the non-imaging solar concentrator is formed by sealing a top transparent dome and bottom reflective Compound Parabolic Concentrator (CPC) 110 together, and the central lines of the 2 parabola used to construct the CPC form the half-acceptance angles θ_{C} with the central line of the non-imaging solar concentrator. The incident beam light I_{b} and diffuse light I_{d} form the incident angles with the central line of the non-imaging solar concentrator. As long as the incident angles are smaller than the θ_{C}, all incident lights no matter beam light or diffuse light will be concentrated to the bottom receiver.

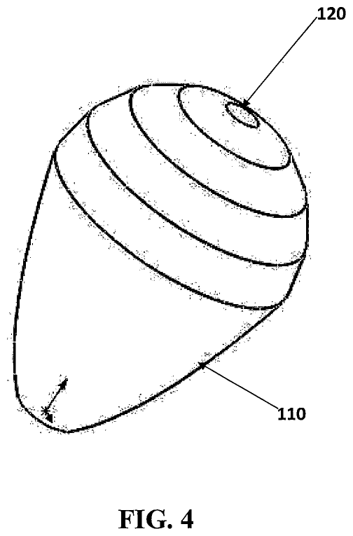

Referring to FIG. 4, the non-imaging non-tracking high concentration ratio solar concentrator is fabricated with a CPC 110 and a domed divergent Fresnel lens cover 120.

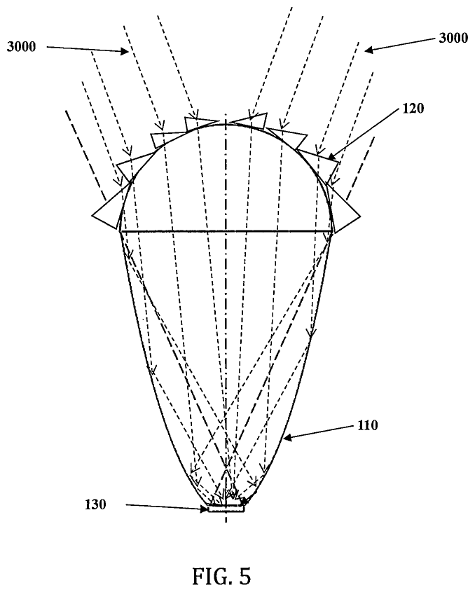

Referring to FIG. 5, the general work principle of the domed divergent Fresnel lens and CPC based non-tracking non-imaging concentrating system is elucidated. The obliquely incident light 3000 is firstly infracted by the divergent Fresnel lens 120 to changing its incident angle relative to the CPC, and make it smaller than the half acceptance angle of the CPC, then is concentrated by the CPC non-imaging concentrator 110.

The work principle of the non-tracking concentrator structure is elucidated as the following. As the sun moving from east to west, the sunlight is refracted to change direction by various portion of the domed divergent Fresnel lens surrounding the CPC, so that the refracted sunlight falls into the relatively small acceptance half-angle of the CPC. The addition of the domed divergent Fresnel lens to the CPC enlarges the acceptance angle of the CPC, and therefore enables the stationary concentration with high concentration ratio.

From the description above, a number of advantages of the non-imaging non-tracking solar concentrator based combined CSP and wave energy and wind energy conversion hybrid thermal energy and electric power cogeneration system become evident. The synergistically combination of CSP system, wave energy conversion system, and wind energy system enables harnessing solar energy, wave energy, and wind energy by using a single system simultaneously. The non-imaging non-tracking solar concentrator does not only provides lifting force for wave energy converter system and serves as floating platform of wind turbines, but also concentrates both beam sunlight and diffuse sunlight in high concentration ratio. The extension of solar collection area by increasing the volume of the non-imaging non-tracking solar concentrator will directly benefit the harvesting of wave energy and wind energy. The floating CSP system enables ultra-high efficiency, substantial low cost, and super-stable solar power generation through solar thermal and photovoltaic cogeneration, stationary concentration, and electrothermal energy storage. The swappable battery modules address the issue of power transportation and utilization. The side product of the system addresses another grand challenge the human being is facing fresh water shortage. The system of the present invention provides an approach to explore the almost unlimited ocean surface to address the conflict between the land use for power generation and the land uses for other purposes. The present invention also provides a new design paradigm for solar systems, which are mainly based on flat plate photovoltaic panels, and profoundly changes the landscape of solar industry.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A non-imaging non-tracking solar concentrator based combined CSP and wave energy and wind energy conversion hybrid thermal energy and electric power cogeneration system comprises: 1) a divergent Fresnel lens and non-imaging concentrator enabled non-imaging non-tracking solar concentrator based hybrid solar thermal and photovoltaic CSP system; 2) a wave energy converter system; 3) a vertical axis wind energy system; wherein, the CSP system serves as a floating platform for the wave energy system to generate electric power and provides support to wind energy system; the CSP system is connected to the piston of the wave energy converter system through a upper spring; the wave energy converter system is connected to the bed of ocean through a lower spring; the electric generator and the flywheel are connected to the wave energy converter system through the crankshaft. The wave energy converter system and the wind energy system are electrically connected to battery bank with swappable battery modules of the CSP system.

2. The divergent Fresnel lens and non-imaging concentrator enabled non-imaging non-tracking solar concentrator based hybrid solar thermal and photovoltaic CSP system comprises: 1) a divergent Fresnel lens and non-imaging concentrator enabled non-imaging non-tracking solar concentrator array with hybrid solar thermal and photovoltaic receivers; 2) a high temperature thermal energy storage with an electric heater; 3) a thermal power generation system; 4) a condenser and fresh water producer with an electric heater; 4) a battery bank with swappable battery modules; wherein, the hybrid solar thermal and photovoltaic receivers are electrically connected to the battery bank through cables and thermally connected to the high temperature storage and the condenser and fresh water producer through heat transfer pipes; the battery bank is electrically connected to the high temperature thermal storage and the condenser and fresh water producer through electric heaters.

3. The wave energy converter system of claim 1 comprises: 1) a piston ; 2) two connection rods; 3) a crankshaft; 4) a electric generator; 5) a flywheel; 6) a lower spring; 7) a upper spring; wherein, wherein the wave energy converter system comprises: a) a piston ; b) two connection rods; c) a crankshaft; d) a electric generator; e) a flywheel; f) a lower spring; and g) a upper spring; wherein, the upper spring is connected to the piston, the connection rods are connected to the piston and the crankshaft, and the electric generator and the flywheel are connected to the crankshaft; the lower spring is connected to the joint of the two connection rods.

4. The battery bank of claim 2 is assembled with swappable battery modules which can be swapped with battery swappable electric vehicles.
